(19) United States
(12) Patent Application Publication
(10) Pub. No.: US 2006/0032541 A1
(43) Pub. Date: Feb. 16, 2006

(54) Electro-hydraulic manifold assembly with mounted pressure sensors

(75) Inventors: Greg Edward Ford, Detroit, MI (US); Timothy J. Green, Holly, MI (US); David E. Herbert, Rochester Hills, MI (US); Harold L. Bowman, Lapeer, MI (US); Peter Martin Jacobsen, Oakland Township, MI (US); Mark L. Dell'Eva, Grand Blanc, MI (US)

Correspondence Address: Anna M. Shih, 26201 Northwestern Hwy., P.O. Box 766, Southfield, MI, 48037, US

(73) Assignee: Eaton Corporation, Cleveland, OH (US)

(21) Appl. No.: 11/202,744

(22) Filed: Aug. 12, 2005

Related U.S. Application Data
(63) Continuation-in-part of application No. 10/401,408, filed on Mar. 28, 2003, now Pat. No. 6,929,031.

(51) Int. Cl. F17D 1/00

(52) U.S. Cl. 137/884

(57) ABSTRACT

An electro-hydraulic manifold assembly with a plurality of solenoid operated valves disposed on a manifold block and each operable to control pressure from the inlet to a separate outlet. Sensing ports are provided in each outlet with a pressure sensor sealed over the sensing port for providing a signal indicative of the sensed pressure. The pressure sensors are mounted on a interface and electrically connected to the interface. The interface has slots therein which permit the frame to be simultaneously electrically connected by bayonet connection to the terminals on each solenoid valve as the transducers are sealed over the sensing ports and the interface attached to the manifold block.

This is a continuation-in-part of application U.S. Ser. No. 10/401,408 filed on Mar. 28, 2003, which is now U.S. Pat. No. 6,929,031.

### BACKGROUND OF THE INVENTION

The present invention relates to manifold assemblies of the type having an hydraulic fluid pressure inlet communicating with a plurality of valve chambers, each having an electrically operated valve ported therein for controlling, upon energization, fluid pressure selectively to individual outlets for the respective valving chambers. Manifolds of this type are employed for controlling pressure of hydraulic fluid in servo-actuators as, for example, clutch actuators in automatic speed-change power transmissions for motor vehicles where it is desired to control the speed change or shifting patterns of the transmission with an electronic controller. This arrangement has found widespread use in modern vehicle automatic transmissions because the electronic controller can receive in real time multiple inputs of vehicle operating parameters such as road speed, throttle position and engine RPM. The electronic controller can also be programmed to provide optimum shifting patterns based upon known engine power available, vehicle mass and the operating parameter inputs.

However, in providing a shifting pattern for controlling hydraulic fluid pressure to each of the transmission speed change clutch actuators for effecting the desired shifting, it has been found that providing pressure sensors at the outlet of each of the electrically operated valves can provide a clutch actuator pressure signal in real time which is in actuality an analog of the force on the clutch, which is in turn proportional to the torque transmitted by the clutch during engagement and disengagement. This arrangement gives an electrical signal proportional to torque transmitted for a particular gear set and thus provides real time closed loop control of the transmission shifting. This arrangement is a desirable alternative to predetermined shifting algorithms for open loop shift control by the electronic controller.

However, providing the pressure sensors at each electrical valve outlet to generate an electrical signal indicative of the shift clutch actuating pressure, increases the complexity, size and cost of the assembly because this structure requires individual electrical leads that connect the plurality of sensors and electrically operated valves on the manifold. In previously known structures, individual wire leads with connector terminals are connected to each pressure sensor and solenoid terminals on each valve and the leads bundled to form a wiring harness. This requires a prohibitively large space for access to the terminals and the wiring harness within the transmission casing for the manifold assembly.

Accordingly, it has been desired to find a way or means of electrically connecting to the plurality of pressure sensors and solenoid operated valves in a transmission shift control module or manifold assembly in a manner which is simple and easy to install in mass production and yet is sufficiently low in cost to render the technique desirable for competitive high volume light vehicle production.

### BRIEF SUMMARY OF THE INVENTION

The present invention provides an electro-hydraulic manifold assembly with a plurality of solenoid operated valves for controlling pressure to individual or discrete pressure outlets in the manifold block and has a sensing port in each outlet. A plurality of pressure sensors are mounted on an interface with electrical leads attached to electrically conductive strips provided in the interface to connect with terminals on each valve upon attachment of the interface to the block. When the interface is attached to the manifold block, the transducers each communicate respectively with one of the sensing ports.

The present invention thus permits individual connection of the electrical leads to the solenoid operated valves and installation of the pressure transducers in one operation when the interface is attached to the manifold block.

### BRIEF DESCRIPTION OF THE DRAWINGS

FIG. 1 is a perspective view of the assembled manifold block, valve, pressure sensors and interface according to one embodiment of the invention;

FIGS. 2a and 2b are a single exploded view of the assembly of FIG. 1 divided along separation line 1′-11;

FIG. 3 is a plan view of the assembly of FIG. 1;

FIG. 4 is a section view taken along section indicating lines 44 of FIG. 3;

FIG. 5 is a section view taken along section indicating lines 5-5 of FIG. 3;

FIG. 6 is an enlarged view of a portion of FIG. 3 showing an alternate embodiment of the pressure sensor arrangement;

FIG. 7 is a section view taken along section-indicating lines 7-7 of FIG. 6;

FIG. 8 is a plan view of an interface that may be used in another embodiment of the invention; and

FIG. 9 is a plan view of an interface that may be used in a further embodiment of the invention.

### DETAILED DESCRIPTION OF THE INVENTION

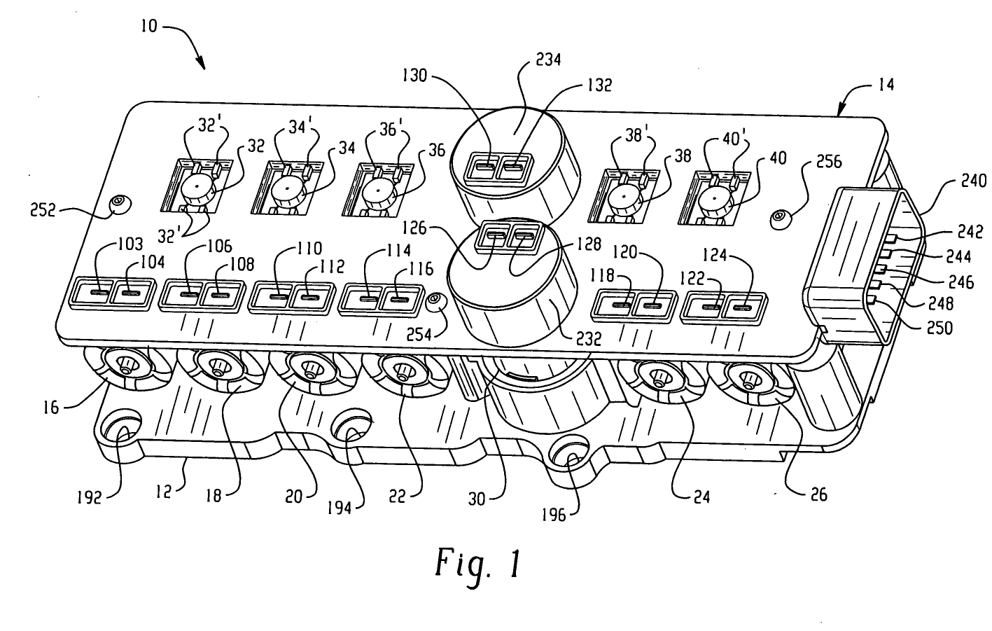

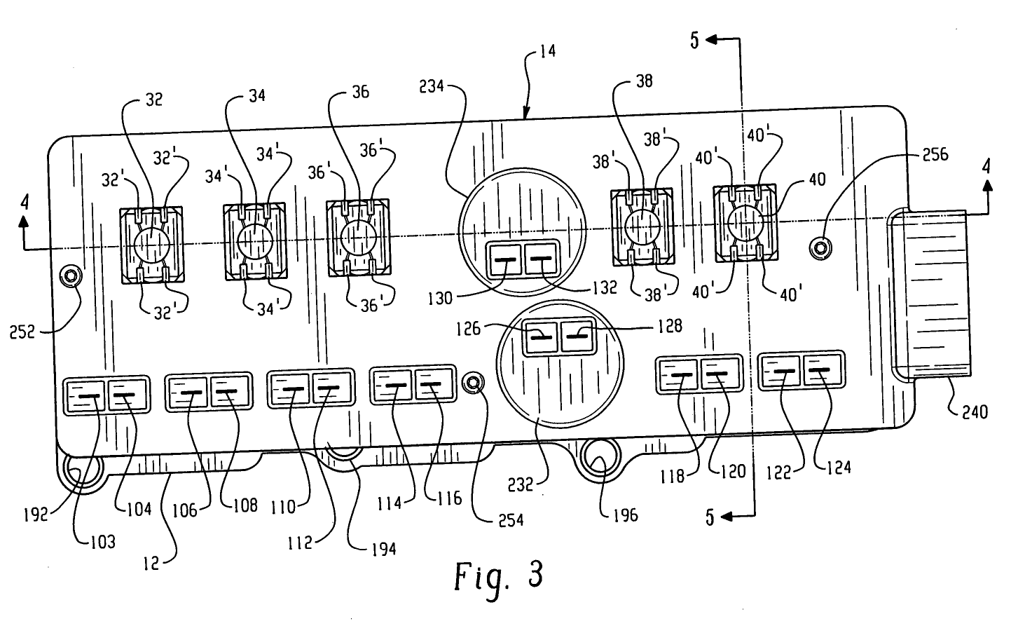

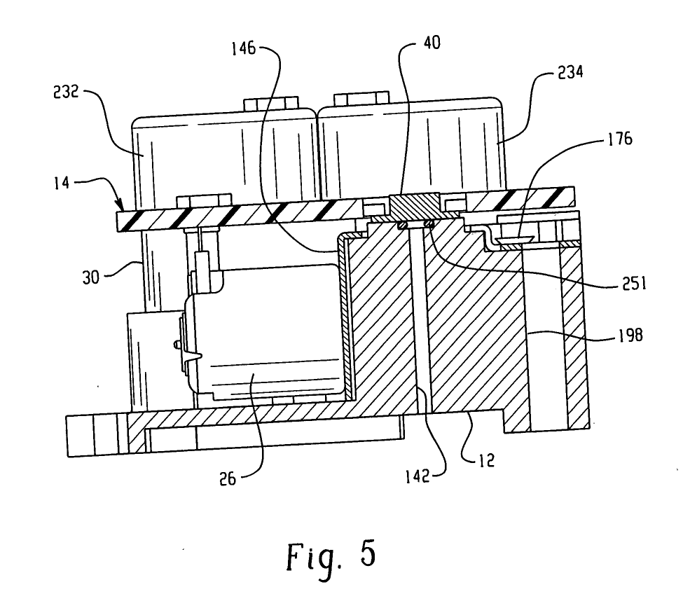

Referring to FIGS. 1 through 5, one embodiment of the invention is indicated generally at 10 and includes a manifold block 12, an electrical interface indicated generally at 14 and a plurality of solenoid operated valves 16, 18, 20, 22, 24, 26, 28, 30. Although these figures show a lead frame as the interface 14, the interface 14 can be any structure that distributes communication signals and power, such as a fiber optic cables, plated traces, flexible circuits, wire harnesses, wireless interfaces, etc., as will be described in greater detail below.

The interface 14 includes a plurality of pressure sensors or transducers 32, 34, 36, 38, 40, each having leads secured or attached to electrically conductive pads denoted respectively by the primed reference numeral for each of the transducers.

The manifold block 12 has a plurality of valving cavities 42, 44, 46, 48, 50, 52, formed horizontally in the vertically extending side 54 of the manifold block 12, with each of the valving cavities having an outlet passage denoted respectively 56, 58, 60, 62, 64, 66 which are connected (not shown) to the underside of the block and are adapted to connect with corresponding hydraulic passages in the device to be controlled such as the control pressure passages in an automatic transmission valve body for shifting clutch actuation.

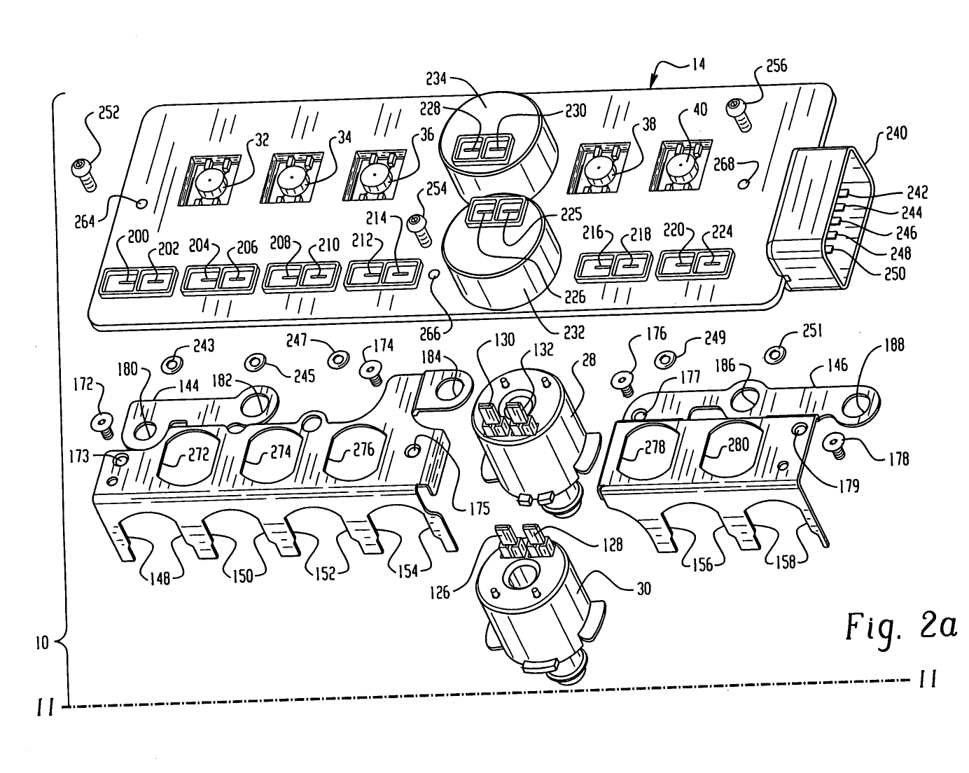

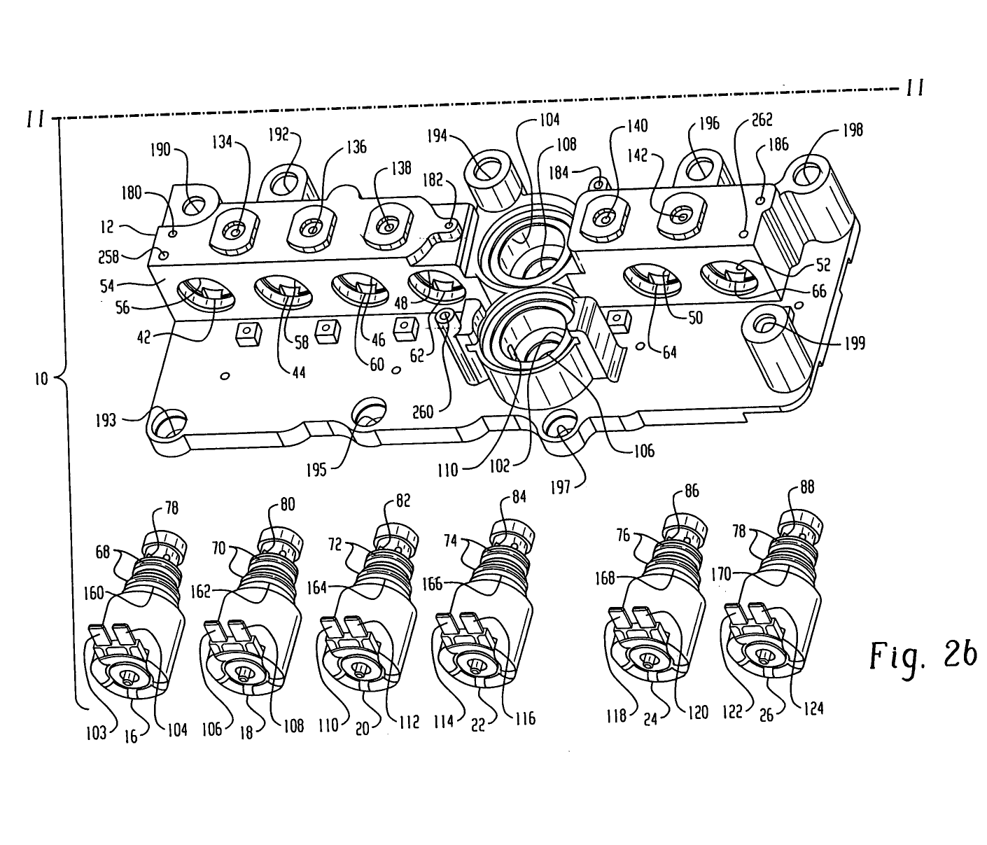

It will be understood that each of the valves 16 through 26 has an outlet passage (not shown) formed thereon between a pair of O-ring seals provided on the valve as denoted by reference numerals 68, 70, 72, 74, 76, 78 in FIG. 2b. It will be understood that an inlet passage (not shown) formed through the valve block communicates with an inlet 90, 92, 94, 96, 98, 100 respectively in the bottom of each of the valving chambers 42, 44, 46, 48, 50, 52 and provides pressurized fluid to the inlets at each of the solenoid valves denoted respectively 78, 80, 82, 84, 86, 88 in FIG. 2b.

Referring to FIGS. 2a and 2b, a pair of auxiliary valve chambers 102, 104 are formed in a horizontally extending upper face of the manifold 12; and, each has an inlet passage respectively 106, 108 formed in the bottom thereof. An outlet port is formed in the side of each of chamber 102, 104 thereof for providing flow to auxiliary functions in the transmission with one of the outlets visible in FIG. 2b and denoted by reference numeral 110. Solenoid operated valves 28, 30 are disposed in the chambers 102, 104 respectively.

Each of the valves 16 through 26 and 28, 30 has a pair of electrical connector terminals denoted respectively 103 through 132 extending in an upward direction therefrom for connection thereto as will hereinafter be described.

Block 12 has a plurality of spaced sensing ports provided on the upper surface thereof and denoted respectively by reference numerals 134, 136, 138, 140, 142; and, each of the ports 134 through 142 may be connected internally within the block to one of the outlet passages 56 through 66 respectively by intermediate passages (not shown) within the block. Alternatively, ports 134-142 may be connected to passages in the transmission valve body.

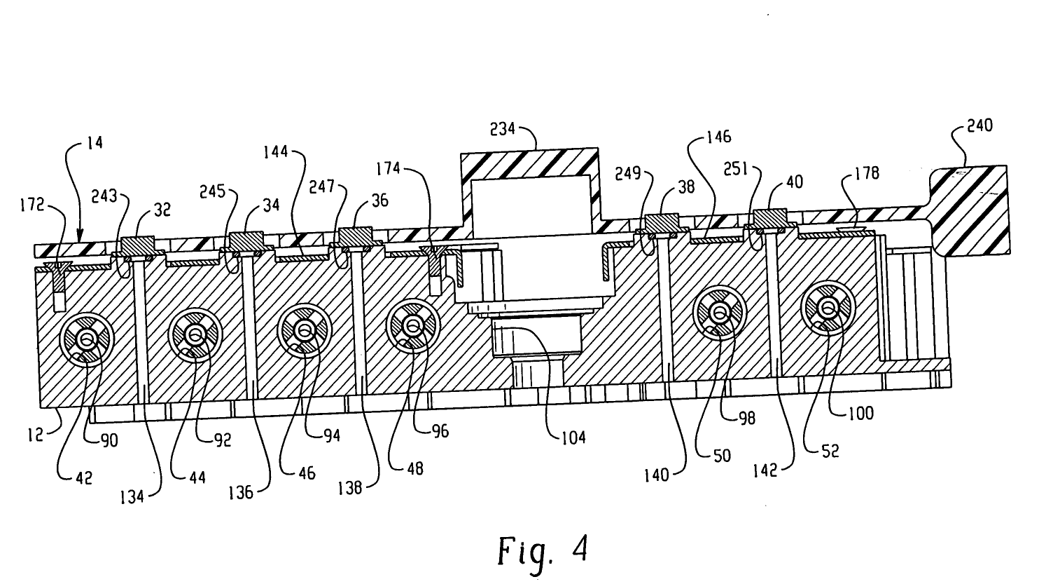

Referring to FIGS. 2a and 4, a pair of brackets having a generally right angle configuration denoted by reference numerals 144, 146 are provided with bifurcations or slots respectively 148 through 158 and are received over grooves denoted respectively 160 through 170 on the solenoid valves 16 through 26 respectively as shown in FIG. 2b for retaining the valves in their respective valving cavities. Brackets 144, 146 are retained on the manifold block 12 by screws 172, 174, 176, 178 through apertures 173, 175, 177, 179 in the brackets and which threadedly engage tapped holes 180, 182, 184, 186 provided in the upper surface of the block 12.

The brackets additionally have apertures 180, 182, 184, 186, 188 respectively formed therein which coincide with retaining fastener holes 190, 192, 194, 196, 198 provided in the manifold block for retaining bolts or screws (not shown) to pass therethrough for connection to a transmission housing. Similarly, manifold block has additional holes 193, 195, 197, 199 for receiving bolts or screws therethrough for attachment to a transmission deck.

Referring to FIGS. 1, 2a, 3, 4 and 5, the interface 14 has a plurality of slots 200 through 224 formed therein in pairs in spaced arrangements and located on the interface so as to be positioned for connection to electrical terminals 103 through 124 of valves 16 through 26 respectively. A second set of slots 225 through 230 is provided on the top of raised portions 232, 234 formed in the interface to accommodate the vertically extending valves 28, 30, and, slots 225 through 230 are positioned so as to each be located directly above one of the electrical terminals 126 through 132 respectively.

The interface 14 has an electrical receptacle portion 240 formed on one end thereof which has a plurality of electrical connector pins provided therein, five of which are shown and denoted by reference numerals 242 through 250 in the drawings. It will be understood that the electrical terminals such as terminals 242 through 250 are respectively connected to conductive strips (not shown) extending within the frame 14 and which are each connected respectively to one of the pads such as 32′, 34′, 36′, 38′, 40′ and also to unshown strips which have portions thereof exposed in the slots 200 through 224 and slots 226 through 230. Thus, the entire interface 14 in this embodiment is received over the manifold block 12 and simultaneous electrical connection is made with the terminals 103 through 132. The interface 14 is then secured to the block 12 by screws 252, 254, 256. Note that separate fasteners are not necessarily needed to secure the interface 14 to the block 12; for example, the interface may be attached directly to the block 12.

Referring to FIGS. 2a, 4 and 5, a plurality of O-rings denoted respectively 243, 245, 247, 249, 251 are disposed respectively each in a counter bore or annular groove formed at the top of each of the sensing ports 134 through 142 and provide for sealing about the upper end of the port with the undersurface of the respective pressure transducer 32 through 40 associated therewith. The O-rings are pre-placed in the counter bores and are each sealed respectively against the undersurface of one of the sensors 32 through 40.

Referring to FIG. 2a, it will be apparent that brackets 144 and 146 have clearance apertures denoted respectively 272, 274, 276 and 278, 280 formed therein to provide clearance about the sensing ports 134 through 142 for the pressure sensors 32 through 40 to extend upwardly through the brackets.

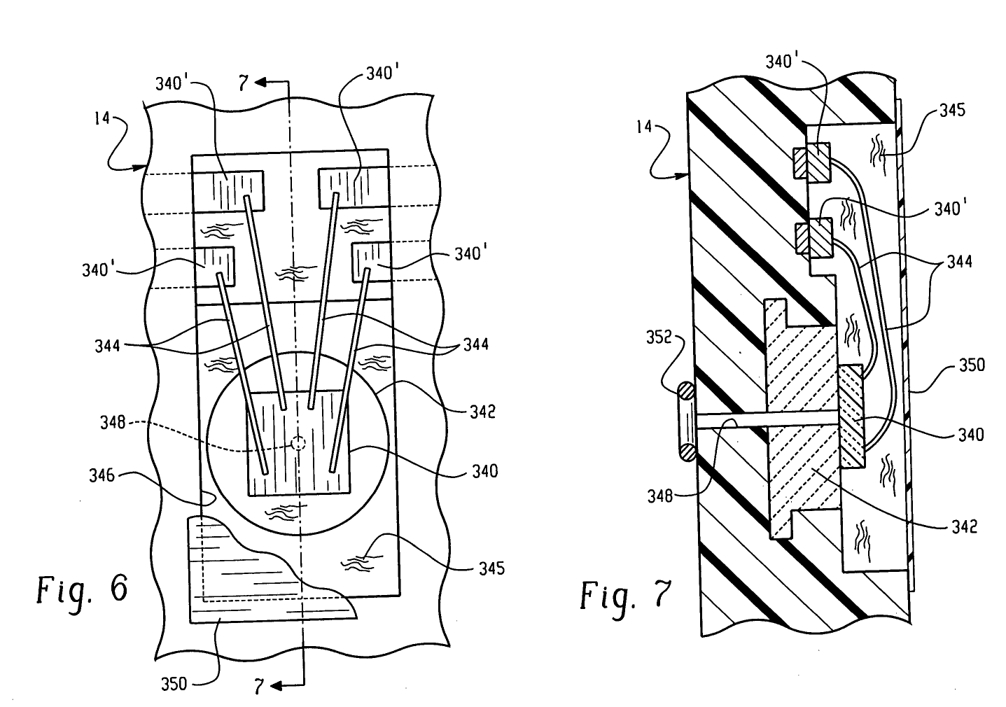

Referring to FIGS. 6 and 7, one possible arrangement or embodiment for mounting of a typical solid state pressure sensor die 340 is illustrated wherein the die is mounted on a ceramic disk 342 with leads 344 extending from the die for attachment to exposed pads 340′ provided at the ends of the conductors, shown in dashed outline in FIG. 6, which are embedded in the interface 14. Die 340 is bonded such as by the use of epoxy resin or other suitable adherent to the ceramic disk. The lead wires 344 from the die are then attached one each to the pads 340′ respectively by any suitable expedient such as weldment. A recessed cavity 346 provided in the interface 14 surrounding the die 340 is then filled with a suitable potting agent 345 as, for example, silicone gel, to protect the electrical connections. The recessed cavity as filled with the silicone gel may then be sealed with a suitable plastic cover 350 for further protection. It will be understood that the pressure signal enters through a suitable aperture or sensing hole 348 to apply the sensed pressure to the undersurface of the die 340. The disk 342 is sealed over the manifold sensing port by a suitable resilient seal ring 352. It will be understood that the sealing for the pressure sensor and the sensing port of the manifold for the embodiment of FIGS. 6 and 7 is accomplished in the same manner as that for the embodiment 10 of FIGS. 1 through 5.

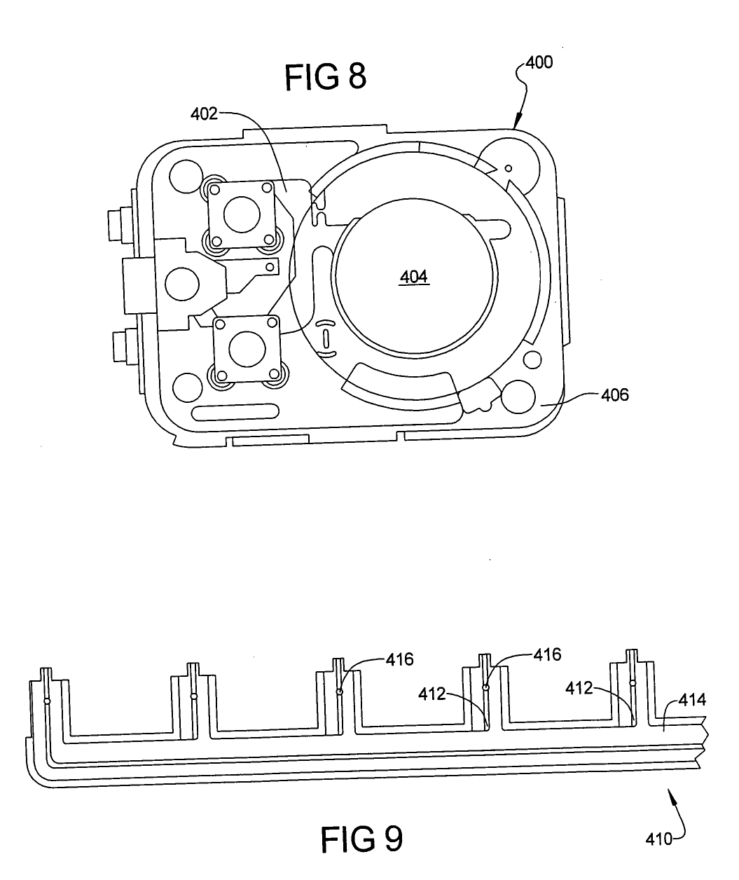

FIGS. 8 and 9 show possible alternative structures that may be used for the interface 14. Those of ordinary skill in the art will understand how these alternative interfaces 14 may be incorporated into the inventive system 10. FIG. 8 shows an example of a plated trace 400 that includes a conductive trace 402 and a conductive mounting area 404 applied to a non-conductive base 406, such as a polymer base. The conductive mounting area 404 is used to mount a pressure transducer and interconnect to a transmission control unit (TCU). Applying the plated trace 400 to the base 406 allows attachment of the pressure transducer to the manifold 12.

FIG. 9 shows an example of a flex circuit 410 that may be used as the interface 14. The flex circuit 410 would be mounted to the manifold 12 to allow interconnection of pressure transducer assemblies in the system 10. The flex circuit 410 includes a plurality of branches 412 that extend from a main line 414. Each branch 412 may include a hole 416 for connecting the flex circuit 410 to electrical connector pins via any known manner.

The present invention thus provides a unique and novel construction of a interface with solid state pressure transducers electrically connected thereto such that the interface may be installed upon an electro-hydraulic manifold block and simultaneously electrically connected to electric terminals for the valve solenoid operators thereon and to also simultaneously make a pressure sealed connection with sensing ports provided in the manifold block. The present invention provides a simple and easy to assemble construction for an electro-hydraulic manifold assembly and eliminates the need for wiring harnesses, thereby providing a cost effective construction for high volume production of such a manifold.

The invention is not limited to systems having the interfaces shown in the figures. From these examples, one of ordinary skill in the art will understand that other interfaces, such as fiber optics, wire harnesses, wire systems, etc. may also be used without departing from the scope of the invention.

Although the invention has hereinabove been described with respect to the illustrated embodiments, it will be understood that the invention is capable of modification and variation and is limited only by the following claims.

What is claimed is:

1. An electro-hydraulic manifold assembly comprising:
a manifold block having an inlet port communicating with a plurality of valving chambers, with each chamber having a discrete outlet port and a pressure sensing port communicating with each outlet port;
an electrically operated valve disposed to control pressure in each of said chambers between said inlet port and the respective discrete outlet port;
an interface disposed on said block having a plurality of sets of electrical terminals, with each set making electrical connection with one of said valves,
wherein the interface includes a plurality of inserts, each insert having a passage therethrough with each passage positioned to communicate respectively with one of said pressure sensing ports, and
wherein each insert has a pressure transducer thereon communicating with said passage.

2. The assembly defined in claim 1, wherein the interface is one selected from the group consisting of a lead frame, fiber optic cable, plated trace, flex circuit, wire harness, and wireless interface.

3. The assembly defined in claim 1, wherein the interface is a plated trace having a conductive trace and a conductive mounting area for mounting the pressure transducer, and wherein the plated trace is disposed on a non-conductive base.

4. The assembly defined in claim 1, wherein the interface is a flex circuit having a plurality of branches, each branch connected an electrical connector to form the electrical connections with said valves.

5. The assembly defined in claim 1, wherein said inserts are formed of ceramic material.

6. The assembly defined in claim 1, wherein each of said pressure transducers comprises a die electrically connected to a conductor on said interface.

7. The manifold assembly defined in claim 1, wherein said sets of electrical terminals and said pressure transducers are connected to a common receptacle on said interface for external electrical connection thereto.

8. The manifold assembly defined in claim 1, wherein said pressure transducers have leads attached to pads formed on electrical conductors on said interface.

9. The manifold assembly defined in claim 1, wherein the inserts are embedded with a surface thereof exposed.

10. A method of making an electro-hydraulic manifold assembly comprising:
forming an inlet passage and a plurality of spaced valving chambers in a block, each valving chamber having a discrete outlet passage that communicates with a sensing port formed in each outlet passage;
forming an electrical interface having a plurality of sensing orifices. wherein each sensing orifice is aligned with one of the sensing ports and disposing a plurality of inserts therein each having a passage communicating with one of said sensing orifices;
mounting an electrically operated valve in each valving chamber and porting the valve for controlling pressure from the inlet passage to the respective discrete outlet;
mounting a pressure transducer over each of said insert passages and electrically connecting the transducer to the interface; and,
attaching said interface to the block and aligning each of said sensing orifices with one of said sensing ports and electrically connecting said interface to each of said valves.

11. The method of claim 9, wherein the step of attaching said interface comprises attaching to the block at least one component selected from the group consisting of a lead frame, fiber optic cables, plated traces, a flex circuit, a wire harness, and a wireless interface.

12. The method defined in claim 10, wherein the step of disposing the plurality of inserts includes disposing ceramic inserts.

13. The method defined in claim 10, wherein the step of disposing a plurality of inserts includes embedding the plurality of inserts to leave a surface of each insert exposed.
